(19) United States
(12) Patent Application Publication
(10) Pub. No.: US 2006/0184795 A1
(43) Pub. Date: Aug. 17, 2006

(54) System and method of reducing session transfer time from a cellular network to a Wi-Fi network

(75) Inventors: Anil Doradla, Austin, TX (US); Rias Muhamed, Austin, TX (US)

Correspondence Address: TOLER SCHAFFER, LLP, 5000 PLAZA ON THE LAKES, SUITE 265, AUSTIN, TX, 78746, US

(73) Assignee: SBC Knowledge Ventures, L.P.

(21) Appl. No.: 11/056,929

(22) Filed: Feb. 11, 2005

(51) Int. Cl. H04L 9/00

(52) U.S. Cl. 713/167

(57) ABSTRACT

A method of transferring a data session of a portable computing device from a cellular network and to a wireless fidelity (Wi-Fi) network is described. The method includes establishing a data session between a cellular network device and a portable computing device while the cellular network device is within a cellular communication region of the cellular network. Further, the method includes receiving a request to begin an advanced Wi-Fi authentication with one or more Wi-Fi access control nodes that provide Wi-Fi data communication coverage within a Wi-Fi coverage region of the Wi-Fi network. The Wi-Fi network coverage is within the cellular communication region. Further, the advanced Wi-Fi authentication includes authenticating the portable computing device with the Wi-Fi network during the data session with cellular network device before the portable computing device accesses the Wi-Fi network.

### FIELD OF THE DISCLOSURE

The present disclosure relates to advanced authentication of a portable computing device having access to a cellular network and a Wi-Fi network.

### BACKGROUND

Currently, cellular data networks and wireless fidelity (Wi-Fi) networks are deployed as separate, standalone networks. Further, each network includes its own method or process for authenticating user devices such as portable computing devices. Since these networks are standalone, a portable computing device that has been authenticated on a cellular network cannot transfer an authenticated session from the cellular network to a Wi-Fi network without performing a second authentication process for the Wi-Fi network. The authentication process on the Wi-Fi network can take anywhere from a few hundred milliseconds to several seconds, depending on the type of authentication infrastructure and protocols utilized by the Wi-Fi network.

When initiating a new session on the Wi-Fi network, the time of authentication is usually acceptable. However, when transferring from a cellular network to the Wi-Fi network, a long authentication time can be quite intolerable if the user is transitioning from the cellular network to the Wi-Fi network during a data session, such as during a file download. During such a transfer, is would be desirable for the authentication process for the Wi-Fi network to be fast enough to prevent the user from experiencing any discontinuity of service. In other words, it is desirable that the transfer be as seamless and transparent as possible to the user.

For an existing portable computing device that includes a cellular interface and a Wi-Fi interface, it would be beneficial to handle network transfers without having to modify the portable computing device.

Accordingly, there is a need for an improved system and method of transferring a portable computing device from a cellular network to a Wi-Fi network.

### BRIEF DESCRIPTION OF THE DRAWINGS

The present invention is pointed out with particularity in the appended claims. However, other features are described in the following detailed description in conjunction with the accompanying drawings in which:

FIG. 1 is a block diagram representative of a communication system;

FIG. 2 is a block diagram representative of a portable computing device;

FIG. 3 is a flow chart to illustrate a first portion of a method of transferring from a cellular network to a Wi-Fi network; and

FIG. 4 is a flow chart to illustrate a second portion of a method of transferring from a cellular network to a Wi-Fi network.

### DETAILED DESCRIPTION OF THE DRAWINGS

A method of transferring a data session of a portable computing device from a cellular network and to a wireless fidelity (Wi-Fi) network is described. The method includes establishing a data session between a cellular network device and a portable computing device while the cellular network device is within a cellular communication region of the cellular network. Further, the method includes receiving a request to begin an advanced Wi-Fi authentication with one or more Wi-Fi access control nodes that provide Wi-Fi data communication coverage within a Wi-Fi coverage region of the Wi-Fi network. The Wi-Fi network coverage is within the cellular communication region. Further, the advanced Wi-Fi authentication includes authenticating the portable computing device with the Wi-Fi network during the data session with cellular network device before the portable computing device accesses the Wi-Fi network.

In a particular embodiment, the request is received from the portable computing device. Alternatively, the request is received from the cellular network device. The method further includes receiving two or more identification parameters. The two or more identification parameters can include a user identification associated with a Wi-Fi network account, a media access control (MAC) address associated with the portable computing device, and a cellular network identification of a user associated with the portable computing device.

In a particular embodiment, the method includes determining a location of the portable computing device. The location of the portable computing device can be determined using a cell identifier parameter obtained from the cellular network device. Particularly, the cell identifier parameter is received from the cellular network device via a parlay gateway and a home location register. Additionally, in a particular embodiment, the method includes identifying one or more Wi-Fi public access control nodes within the cellular communication coverage region in which the portable computing device is located. A request for an advanced authentication can be transmitted to at least one Wi-Fi public access control node within the cellular communication coverage region. Further, the two or more identification parameters can be transmitted to at least one Wi-Fi public access control node. Also, a unique one-time use token can be transmitted to the at least one Wi-Fi public access control node.

In another embodiment, a method of connecting a portable computing device to a wireless fidelity (Wi-Fi) network is described and includes establishing a connection with a cellular network and transmitting an indication to a Wi-Fi-to-cellular transitional authentication server (WCTAS) to perform an advanced authentication process in which the portable computing device is pre-authorized to access the Wi-Fi network before the portable computing device requests access to the Wi-Fi network.

In yet another embodiment, a system is described and includes a wireless fidelity (Wi-Fi) network and a cellular network. A Wi-Fi-cellular transitional authentication server can be coupled to the Wi-Fi network and the cellular network. Particularly, the WCTAS includes a database of Wi-Fi public access control nodes and a computer program embedded within a computer readable medium. The computer program includes logic to locate one or more Wi-Fi public access control nodes located within a cellular coverage region based on a location of a portable computing device served by the cellular coverage region.

In still another embodiment, a portable computing device is described and includes a processor, a cellular communication interface that is responsive to the processor, and a wireless fidelity (Wi-Fi) communication interface that is responsive to the processor. The portable computing device also includes a computer readable that is accessible by the processor and a computer program is embedded within the computer readable medium. Further, the computer program can include instructions to request an advanced authentication process in which the portable computing device is pre-authorized to access a Wi-Fi network after a cellular connection is established, but before the portable computing device has access to the Wi-Fi network.

In yet still another embodiment, a server that is coupled to a cellular network and to a wireless fidelity (Wi-Fi) network is described. The server includes a processor, a computer readable medium accessible to the processor, and a database of Wi-Fi public access control nodes. A computer program is embedded within the computer readable medium and includes logic to locate one or more Wi-Fi public access control nodes within a cellular communication coverage region in which a portable computing device is currently located.

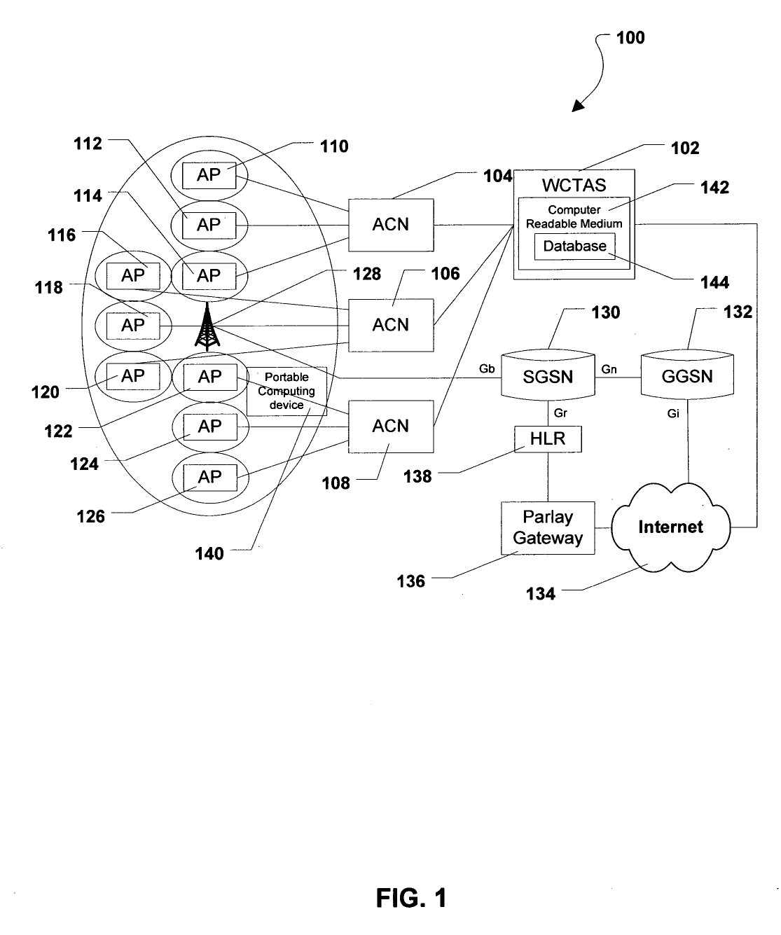

Referring to FIG. 1, a communications system is shown and is generally designated 100. As shown in FIG. 1, the system 100 includes a Wi-Fi to cellular transition authentication server (WCTAS) 102 that is coupled to a first Wi-Fi public access control node (ACN) 104, a second ACN 106, and a third ACN 108. FIG. 1 shows three ACNs 104, 106, 108, but the system 100 can include one or more ACNs. The first ACN 104 can be coupled to a plurality of Wi-Fi access points (AP) 110, 112, 114. Further, the second ACN 106 can also be coupled to a plurality of APs 116, 118, 120. Also, the third ACN 108 can be coupled to a plurality of APs 122, 124, 126. Each AP 110, 112, 114, 116, 118, 120, 122, 124, 126 can provide access to the public Wi-Fi network. In a particular embodiment, each ACN 104, 106, 108 is a device that aggregates traffic from one or more APs and enforces access control to the Wi-Fi networks provided by the APs. In another embodiment, the access control functionality can reside at each AP 110, 112, 114, 116, 118, 120, 122, 124, 126.

FIG. 1 further shows that a general packet radio services (GPRS) network can overlap the public Wi-Fi networks provided by the APs 110, 112, 114, 116, 118, 120, 122, 124, 126. As shown, the GPRS network can include a cellular network tower 128 that is coupled to a serving GPRS support node (SGSN) 130. Further, the SGSN 130 is coupled to a gateway GPRS support node (GGSN) 132. The GGSN 132 is also coupled to a wide area network, such as the Internet 134. As illustrated in FIG. 1, the WCTAS 102 is also coupled to the Internet 134. FIG. 1 further shows a parlay gateway 136 coupled to the Internet 134. The parlay gateway 136 is also connected to a home location register (HLR) 138, which, in turn, is connected to the SGSN 130. In a particular embodiment, the parlay gateway includes one or more APIs into the HLR that facilitates obtaining location information of a selected portable computing device that is served by a cellular communication network.

As depicted in FIG. 1, the system 100 further includes a representative portable computing device 140 that can be used within a cellular communication coverage region provided by the cellular network tower 128. In a particular embodiment, the portable computing device 140 can be a cellular telephone, a portable digital assistant, a laptop computer, or any other portable device with a microprocessor or digital signal processor. Further, during operation of the portable computing device 140 a data session can be transferred from the cellular network to one of the public Wi-Fi networks provided by the APs 110, 112, 114, 116, 118, 120, 122, 124, 126. In a particular embodiment, the transfer from the cellular network to the Wi-Fi network can be facilitated using the method described in detailed below.

As shown in FIG. 1, the WCTAS 102 can include a computer readable medium 142 and a database 144. In an exemplary embodiment, the database 144 includes information related to each Wi-Fi public ACN 104, 106, 108 that includes one or more APs 110, 112, 114, 116, 118, 120, 122, 124, 126 located within the cellular communication coverage region provided by the cellular network tower 128. A cell identifier parameter associated with the cellular network tower 128 can be transmitted to the WCTAS 102 and the WCTAS 102 can search the database 144 in order to locate the APs 110, 112, 114, 116, 118, 120, 122, 124, 126 that are within the cellular communication coverage region provided by the identified cellular network tower 128.

In an alternative embodiment, the system 100 can include other wireless local area networks (LANs) in lieu of, or in addition to, a one or more public Wi-Fi LANs. For example, the system can include one or more Bluetooth LANs, one or more Ultra Wideband (UWB) LANs, one or more High Performance Radio LANs (HIPERLANs), or any other type of wireless LANs. Further, a global system for mobile communications (GSM) network, an enhanced data rates for GSM evolution (EDGE) network, or a third generation (3G) network can overlay the public wireless LAN instead of, or in addition to, the GPRS network.

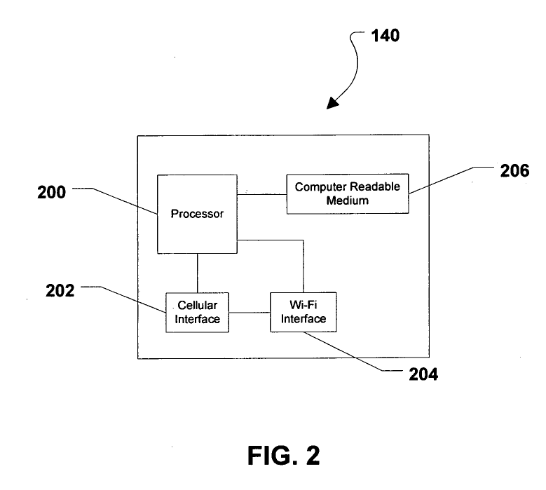

FIG. 2 illustrates one embodiment of the portable computing device 140. As shown, the portable computing device 140 includes a processor 200. A cellular communication interface 202 can be coupled to the processor 200 and can provide two-way cellular communication to and from the portable computing device 140. Further, a Wi-Fi communication interface 204 can be coupled to the processor 200 and can provide two-way Wi-Fi communication to and from the portable computing device 140. FIG. 2 also shows that a computer readable medium 206 can also be coupled to the processor 140. One or more logic steps for authenticating the portable computing device 140 with a Wi-Fi network can be embedded within the computer readable medium 206.

In a particular embodiment, the logic steps can be executed to perform an advanced authentication of the portable computing device 140 with the Wi-Fi network. In other words, the information that is required to authenticate the portable computing device 140 with a Wi-Fi network during the initiation of a standalone Wi-Fi data session is transmitted to the Wi-Fi network before the portable computing device 140 enters the Wi-Fi network. Moreover, this information is transmitted to the Wi-Fi network while the portable computing device 140 is engaged in a data session with a cellular data network and the cellular network continues to provide a data connection to the portable computing device 140 while the advanced authentication is performed. When the portable computing device 140 requests access to the Wi-Fi network, the Wi-Fi network determines if the portable computing device 140 is on a privileged list for devices that have been pre-authenticated. Once the identity of the portable computing device 140 is verified, e.g., by transmitting a unique identifier, an expedited authentication is performed for the portable computing device 140.

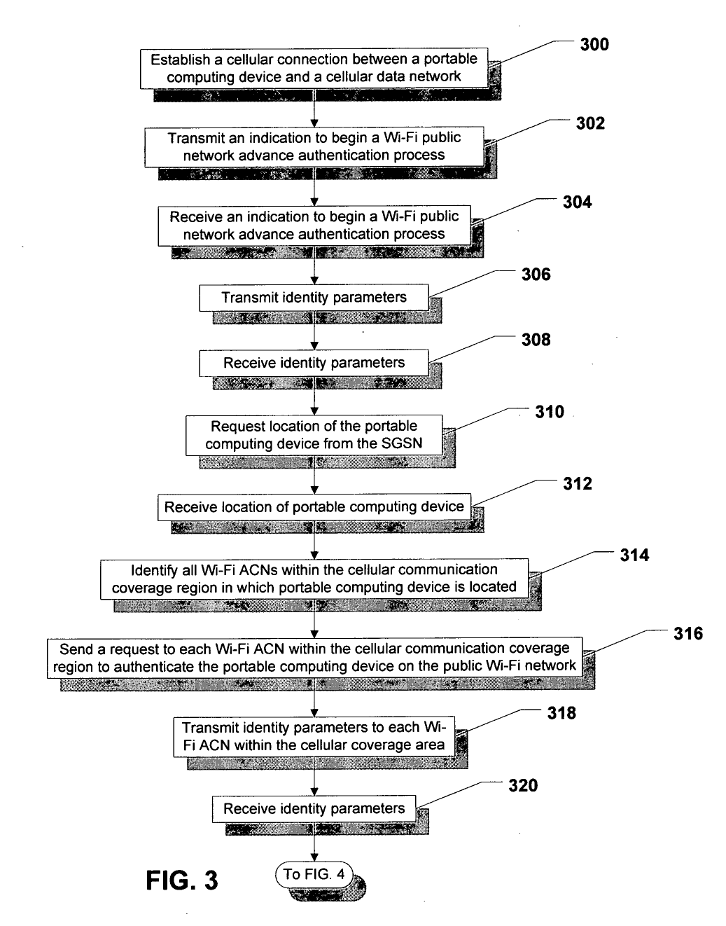

Referring to FIG. 3, a method of transferring a data session of portable computing device from a cellular network to a Wi-Fi network is shown and commences at block 300. At block 300 a cellular connection is established between a portable computing device and a cellular data network. Further, in a particular embodiment, the connection between the portable computing device and the cellular data network is facilitated using a packet data protocol (PDP) context. At block 302, after the portable computing device establishes a PDP context with the cellular data network, the portable computing device transmits an indication to a server, e.g., the WCTAS, to begin a Wi-Fi public network advance authentication process. Moving to block 304, the WCTAS receives an indication to begin the Wi-Fi public network advance authentication process.

In a particular embodiment the communication between the portable computing device and the WCTAS can be established using the Internet protocol (IP). Further, in a particular embodiment, the indication to begin the Wi-Fi public network advance authentication process is automatically sent upon establishing the PDP context. In another embodiment, a user can manually command the portable computing device to send the indication to begin a Wi-Fi public network advance authentication process, e.g., by toggling a button at the portable computing device. In yet another embodiment, a cellular network device, such as the SGSN, can prompt the user via the portable computing device as to whether the user would like to initiate a Wi-Fi public network advance authentication process. In still another embodiment, after the PDP context is established the SGSN can send the indication to begin the Wi-Fi public network advance authentication process.

Moving to block 306, the portable computing device transmits one or more identity parameters to the WCTAS, which receives the identity parameters at block 308. In a particular embodiment, the identity parameters can include a user identification associated with a user's Wi-Fi public network account, a hardware media access control (MAC) address associated with the portable computing device, and a cellular network identification associated with the portable computing device. In a particular embodiment, the cellular network identification can be an international mobile subscriber identity (IMSI) number, a temporary IMSI (TIMSI) number, or a mobile subscriber integrated services digital network (MSISDN) number. After receiving the identity parameters, the WCTAS requests the location of the portable computing device from the SGSN at block 310.

Moving to block 312, the WCTAS receives the location of the portable computing device from the SGSN. In a particular embodiment, the location of the portable computing device is obtained using a cellular identifier (CI) parameter. Further, global positioning or triangulation can be used to obtain the location of the portable computing device.

In an illustrative embodiment, the CI information is obtained from the SGSN via a parlay gateway. Particularly, when the WCTAS makes a query to the cellular network for the CI, the WCTAS contacts the parlay gateway. The parlay gateway, in turn, queries the HLR. For a GPRS network, the HLR is connected to the SGSN via a Gr interface that supports GSM-MAP. The query to the HLR results in the subscriber's information being sent to the HLR and the HLR transmits that information to the WCTAS. In a particular embodiment, the parlay gateway includes one or more application programming interfaces (APIs) into the HLR in order to obtain the location information of the portable computing device.

Thereafter, at block 314, the WCTAS identifies known public Wi-Fi ACNs within the cellular communication coverage region in which the portable computing device is located. In a particular embodiment, the WCTAS searches its database of ACNs to locate the ACNs within the present cellular communication coverage region. Moving to block 316, the WCTAS sends a request to each Wi-Fi ACN within the cellular communication coverage region to perform an advanced authentication of the portable computing device on the public Wi-Fi network. At block 318, the WCTAS transmits the identity parameters, previously received from the portable computing device, to each relevant Wi-Fi ACN within the cellular communication coverage region.

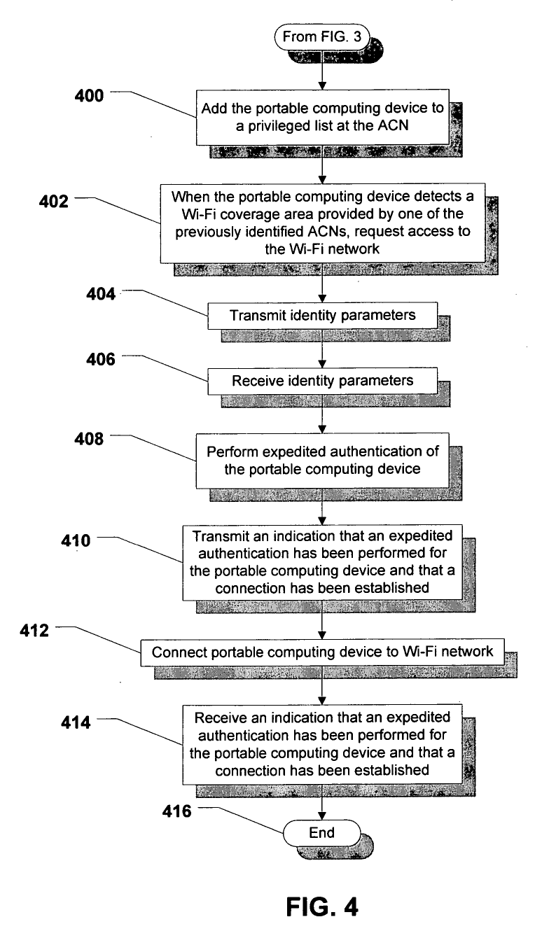

Proceeding to block 320, each relevant ACN receives the identity parameters from the WCTAS. The method then continues to block 400 of FIG. 4. At block 400, after receiving the identity parameters, each ACN adds the portable computing device to a privileged list at each ACN. In a particular embodiment, the privileged list at each ACN entitles the portable computing device to an expedited authentication process that is faster than a normal authentication process used to authenticate users who are not transitioning into the Wi-Fi network.

If the access control function is performed behind the AP and if any association with the Wi-Fi AP is unlimited with traffic being blocked behind the AP, then the access control function is typically performed by inspecting the source MAC address in the Layer 2 traffic packets sent to the AP. The packets are allowed to proceed if the MAC addresses associated with the traffic packets are in an address control list (ACL) associated with the ACN. In such a case, after receiving the authentication request from the WCTAS and after receiving the identity parameters, each identified ACN can add a MAC address associated with the transitioning portable computing device to a privileged list at the ACN and to an access control list (ACL) at the ACN.

Further, if the access control is based on 802.1x port based control, then Wi-F users are not allowed access to a Wi-Fi network without checking with a remote authentication, authorization, and accounting (AAA) server. In such a case, after receiving the authentication request and the identity parameters from the WCTAS, the user identification associated with the portable computing device can be added to a privileged list at the ACN.

At block 402, when the portable computing device enters a Wi-Fi coverage area provided by one of the previously identified ACN, the portable computing device may request access to the Wi-Fi network. At block 404, the portable computing device transmits the identity parameters associated with the portable computing device to the ACN. In a particular embodiment, the identify parameters transmitted to the ACN are the same identity parameters that were previously transmitted to the WCTAS and passed on to the ACN when the advance authentication process was requested. Moving to block 406, the ACN receives the identity parameters from the portable computing device. Next, at block 408, the ACN performs a fast, or expedited, authentication of the portable computing device on the Wi-Fi network. For example, the expedited authentication can be performed since the authentication information was previously sent to the ACN and the portable computing device was placed on a privileged list to receive the expedited authentication.

In a particular embodiment, if the access control function is performed behind the access point, data traffic from the portable computing device would be transmitted without being challenged since the MAC address of the portable computing device was previously added to the ACL at the ACN. In another embodiment, if the access control method of the ACN is based on 802.1x port based control, then during the 802.1x user authentication process the ACN would determine if the portable computing device is on the privileged list. If so, the ACN would simply open the data port and end the authentication process. If the portable computing device is not on the privileged list, a standard 802.1x authentication process would be performed.

In a particular embodiment, when the WCTAS transmits the user identity information to each previously identified ACN within the cellular coverage area in which the portable computing device is currently located, the WCTAS can also transmit a unique, randomly generated one-time token, that is only valid for a particular individual data session, to each previously identified ACN. Also, the WCTAS can transmit the token to the portable computing device and the portable computing device can transmit the token to the ACN when it enters the Wi-Fi network provided by the ACN. In a particular embodiment, if the access control function is performed behind the access point, the ACN challenges the portable computing device to produce the correct one-time token before allowing the portable computing device to connect to the Wi-Fi network provided by the ACN. In another embodiment, if the access control function is based on an 802.1x port based control, then after the ACN determines that the MAC address of the portable computing device is on the privileged list, the ACN can challenge the portable computing device for the correct token before opening the port to the Wi-Fi network.

Continuing to block 410, the ACN transmits an indication that an expedited authentication has been performed for the portable computing device and that a connection has been established. At block 412, the portable computing device is connected to the Wi-Fi network. Proceeding to block 414, the portable computing device receives an indication that an expedited authentication has been performed for the portable computing device and that a connection has been established. The method then ends at state 416.

With the configuration of structure described above, the system and method of reducing session transfer time from a cellular network to a Wi-Fi network can provide a way to transfer a portable computing device from a cellular network to a Wi-Fi network in a manner that reduces disruption of a data session at the portable computing device. Further, the transfer can be performed in a manner that is substantially seamless and transparent to a user of the portable computing device.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of transferring a data session of a portable computing device from a cellular network and to a wireless fidelity (Wi-Fi) network, the method comprising:
establishing a data session between a cellular network device and a portable computing device, the cellular network device within a cellular communication region of the cellular network; and
receiving a request to begin an advanced Wi-Fi authentication with one or more Wi-Fi access control nodes providing Wi-Fi data communication coverage within a Wi-Fi coverage region of the Wi-Fi network, the Wi-Fi network coverage that is within the cellular communication region, wherein the advanced Wi-Fi authentication includes authenticating the portable computing device with the Wi-Fi network during the data session with cellular network device before the portable computing device enters the Wi-Fi network.

2. The method of claim 1, wherein the request is received from the portable computing device.

3. The method of claim 1, wherein the request is received from the cellular network device.

4. The method of claim 1, further comprising receiving two or more identification parameters.

5. The method of claim 4, wherein a first of the two or more identification parameters comprises a user identification associated with a Wi-Fi network account.

6. The method of claim 5, wherein a second of the two or more identification parameters comprises a media access control (MAC) address associated with the portable computing device.

7. The method of claim 6, wherein a third of the two or more identification parameters comprises a cellular network identification of a user associated with the portable computing device.

8. The method of claim 2, further comprising determining a location of the portable computing device.

9. The method of claim 8, wherein the location of the portable computing device is determined using a cell identifier parameter obtained from the cellular network device.

10. The method of claim 9, wherein the cell identifier parameter is received from the cellular network device via a parlay gateway and a home location register.

11. The method of claim 9, further comprising identifying one or more Wi-Fi public access control nodes within the cellular communication coverage region in which the portable computing device is located.

12. The method of claim 11, further comprising transmitting a request for an advanced authentication to at least one Wi-Fi public access control node within the cellular communication coverage region.

13. The method of claim 12, further comprising transmitting the two or more identification parameters to the at least one Wi-Fi public access control node.

14. The method of claim 9, further comprising transmitting a unique one-time use token to the at least one Wi-Fi public access control node.

15. A method of connecting a portable computing device to a wireless fidelity (Wi-Fi) network, the method comprising:
establishing a connection with a cellular network; and
transmitting an indication to a Wi-Fi-to-cellular transitional authentication server (WCTAS) to perform an advanced authentication process in which the portable computing device is pre-authorized to access the Wi-Fi network before the portable computing device requests access to the Wi-Fi network.

16. The method of claim 15, further comprising communicating two or more identity parameters to the WCTAS server.

17. The method of claim 16, further comprising detecting a Wi-Fi access point at the portable computing device.

18. The method of claim 17, further comprising transmitting a request to establish a Wi-Fi connection with the Wi-Fi access point.

19. The method of claim 18, further comprising receiving notice that an expedited authentication has been performed.

20. The method of claim 19, further comprising establishing a Wi-Fi connection with the Wi-Fi network via the Wi-Fi access point.

21. A system, comprising:
a wireless fidelity (Wi-Fi) network;
a cellular network;
a Wi-Fi-cellular transitional authentication server coupled to the Wi-Fi network and the cellular network;
wherein the WCTAS comprises:
a database of Wi-Fi public access control nodes; and
a computer program embedded within a computer readable medium, wherein the computer program comprises logic to locate one or more Wi-Fi public access control nodes located within a cellular coverage region based on a location of a portable computing device served by the cellular coverage region.

22. The system of claim 21, wherein the computer program further comprises logic to begin an advanced Wi-Fi authentication with the one or more Wi-Fi access control nodes while the cellular network continues to provide a data connection to the portable computing device.

23. The system of claim 22, wherein the advanced Wi-Fi authentication begins after a request is received from the portable computing device.

24. The system of claim 22, wherein the advanced Wi-Fi authentication begins after a request is received from a cellular network device.

25. The system of claim 22, wherein the computer program further comprises logic to transmit two or more identification parameters to the one or more Wi-Fi access control nodes.

26. The system of claim 25, further comprising logic to transmit a unique randomly generated one-time token to the at least one Wi-Fi public access control node.

27. A portable computing device, comprising:
a processor;
a cellular communication interface responsive to the processor;
a wireless fidelity (Wi-Fi) communication interface responsive to the processor;
a computer readable medium accessible by the processor; and
a computer program embedded within the computer readable medium, the computer program comprising:
instructions to request an advanced authentication process in which the portable computing device is pre-authorized to access a Wi-Fi network after a cellular connection is established, but before the portable computing device has access to the Wi-Fi network.

28. The portable computing device of claim 27, wherein the advanced authorization process is automatically requested after the cellular connection is established.

29. The portable computing device of claim 27, wherein the advanced authorization process is requested in response to a user selection of a button after the cellular connection is established.

30. The portable computing device of claim 27, wherein the computer program further comprises instructions to transmit two or more identity parameters.

31. The portable computing device of claim 30, wherein the computer program further comprises instructions to detect a Wi-Fi access point.

32. The portable computing device of claim 31, wherein the computer program further comprises instructions to request to a Wi-Fi connection to the Wi-Fi access point.

33. The portable computing device of claim 32, wherein the computer program further comprises instructions to establish the Wi-Fi connection with the Wi-Fi access point.

34. A server that is coupled to a cellular network and to a wireless fidelity (Wi-Fi) network, the server comprising:
a processor;
a computer readable medium accessible to the processor;
a database of Wi-Fi public access control nodes; and
a computer program embedded within the computer readable medium, wherein the computer program comprises logic to locate one or more Wi-Fi public access control nodes within a cellular communication coverage region in which a portable computing device is currently located.

35. The server of claim 34, wherein the computer program further comprises logic to begin an advanced Wi-Fi authentication with the one or more Wi-Fi access control nodes in order to pre-authorize the portable computing device to access the Wi-Fi network before the portable computing device requests access to the Wi-Fi network.

36. The server of claim 35, wherein the computer program further comprises logic to transmit two or more identification parameters to the one or more Wi-Fi access control nodes.

37. The server of claim 36, further comprising logic to transmit a unique randomly generated one-time token to the at least one Wi-Fi public access control node.
